(19) United States
(12) Patent Application Publication
(10) Pub. No.: US 2024/0071233 A1
(43) Pub. Date: Feb. 29, 2024

(54) Processes and Systems for Airspace Design

(71) Applicant: The Boeing Company, Chicago, IL (US)

(72) Inventors: Serguei R. Tiourine, Gothenburg (SE); John Vince, Derby (GB); Curt Alexander Hjorring, Gothenburg (SE); Mats Åke Thomas Lindström, Viskafors (SE); Karl Jonas Alexander Kruuse, Gothenburg (SE); Carl Martin Smedstad, Gothenburg (SE); Michael Milakovic, Gothenburg (SE); Manuel Polaina Morales, Munich (DE)

(21) Appl. No.: 17/896,368

(22) Filed: Aug. 26, 2022

(51) Int. Cl. G08G 5/00

(52) U.S. Cl. CPC G08G 5/0034; G08G 5/0091

(57) ABSTRACT

Systems and methods of a monitoring node to assist an air navigation service provider (ANSP) in the design of an airspace. The monitoring node collects flight data and performs flight simulations for a large geographic region that is outside of the airspace. The monitoring node receives flight data collected by the ANSP for the airspace. The monitoring node supplements their flight data with the data received from the ANSP and performs flight simulations and generates flight plans for the airspace. The flight simulations and flight plans are transmitted to the ANSP which are then used by the ANSP to design the airspace.

### TECHNOLOGICAL FIELD

The present disclosure relates generally to the field of airspace design and, more specifically, to airspace design using flight simulations that utilizing data from the airspace that is merged with more extensive geographic data.

### BACKGROUND

Air navigation service providers (ANSP) provide various air navigation services for an airspace. Services include but are not limited to air traffic management, aircraft communications, weather service, search and rescue, and various aeronautical information services. An ANSP can be either public or private entities and can provide services to various airspaces.

An ANSP can also be responsible for and/or provide input into the design of the airspace. The airspace design can cover many features regarding how aircraft use the airspace, including but not limited to takeoff and landing procedures, route networks, in-flight waypoints, airway segments, approach procedures, and flight elevations. Airspace design can apply to all aspects of an airspace, or one or more limited aspect. In one example, airspace design includes the use of Free Route Airspace (FRA). The FRA is a section of the airspace in which a user can freely plan a route. The FRA can include an entry point into the airspace, an exit point out of the airspace, and can also include one or more intermediate waypoints. The routes can be planned without reference to an air traffic services route network and are subject to availability and air traffic control.

An issue with airspace design is the inability of an ANSP to effectively design an airspace. One reason for the poor designs is that an ANSP can lack high-fidelity end-to-end flight plan analysis and simulation capabilities. These limitations have led to the introduction of limited airspace designs due to their inability to accurately assess flying patterns in a new airspace. Operators within the airspace see limited benefits to aspects of the design, such as design of the FRA, which is frustrating the operators.

### SUMMARY

One aspect is directed to a method of evaluating an airspace design of a subregion of a larger geographic region. The method comprises: receiving at a monitoring node subregion data for airspace of the subregion with the subregion data being received from an air navigation service provider; integrating the subregion data with flight data of geographic region airspace with the flight data being maintained by the monitoring node; processing flight planning simulations using the flight data that has been integrated with the subregion data; generating flight plans from the flight planning simulations; and transmitting the flight plans to the air navigation service provider.

In another aspect, the method comprises receiving the subregion data in Aeronautical Information Exchange Model (AIXM) format.

In another aspect, the subregion is contained within the larger geographic region.

In another aspect, the method further comprises generating the flight plans for flights within Free Route Airspace (FRA) that extend within the airspace of the subregion.

In another aspect, the method comprises processing the flight planning simulations using global weather.

In another aspect, the method further comprises processing the flight planning simulations using flight schedules for one or more of the geographic region and the subregion.

In another aspect, integrating the subregion data with the navigation data comprises replacing a portion of the flight data with the subregion data.

In another aspect, the method further comprises generating the flight data of the geographic region airspace prior to receiving the subregion data from the air navigation service provider.

In another aspect, the method further comprises transmitting the flight data of the geographic region airspace to the monitoring node in ARINC 424 format.

In another aspect, the method further comprises transmitting a flight validation report to the air navigation service provider after integrating the subregion data with the flight data.

In another aspect, the method further comprises ranking the flight plans based on one or more aspects comprising flight efficiencies, fuel usage, and emissions output.

One aspect is directed to a method of evaluating an airspace design of a subregion of a larger geographic region. The method comprises: maintaining flight data for the larger geographic region at a monitoring node; receiving at the monitoring node subregion data for a subregion of the larger geographic region with the subregion data being received from an air navigation service provider; performing flight simulations using one or more of the flight data and the subregion data; generating flight plans from the flight simulations with the flight plans extending within the subregion; analyzing the flight plans and determining one or more key performance indicators for the flight plans; displaying the flight plans and the one or more key performance indicators; and transmitting the flight plans and the one or more key performance indicators to the air navigation service provider.

In another aspect, the method further comprises: processing flight planning simulations using the updated flight data; generating flight plans with the flight planning simulations; and transmitting the flight plans to the air navigation service provider.

In another aspect, the method further comprises: receiving a request from the air navigation service provide; running additional flight simulations using information from the request; and displaying updated flight plans that include the information from the request.

In another aspect, the method further comprises ranking the flight plans based on congestion of a subregion airspace that extends over the subregion.

In another aspect, the method further comprises receiving the subregion data in Aeronautical Information Exchange Model (AIXM) format and integrating the subregion data in the flight data.

In another aspect, the method further comprises generating the flight plans for Free Route Airspace within the airspace of the subregion.

In another aspect, the method further comprises: maintaining the flight data for the larger geographic region at a monitoring node with the navigation data being devoid of any data from the subregion; and generating the updated flight data by adding the subregion data to the flight data.

In another aspect, the method further comprises transmitting the updated flight data to the monitoring node in ARINC 424 format.

One aspect is directed to a non-transitory computer readable medium comprising instructions stored thereon that, when executed by processing circuitry of a computing device, configures the computing device to: receive subregion data for airspace of the subregion with the subregion data being received from an air navigation service provider; integrate the subregion data with flight data of a geographic region that encompasses the subregion; process flight planning simulations using the flight data that has been integrated with the subregion data; generate flight plans from the flight planning simulations; and transmit the flight plans.

In another aspect, the flight plans being limited to the airspace over the subregion.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a monitoring node that monitors a geographic area and an air navigation service provider that monitors a subregion of the geographic area.

FIG. 2 is a flowchart diagram of a process of generating flight data and/or flight plans and designing an airspace for operators.

FIG. 3 is a flowchart diagram of a method of generating flight data using data from a geographic area and from a subregion.

FIG. 4 is a flowchart diagram of a method of generating flight plans for a subregion within a geographic region.

FIG. 5 is a schematic diagram of a monitoring node.

FIG. 6 is a schematic diagram of an ANSP.

### DETAILED DESCRIPTION

The present application is directed to systems and methods provided by a monitoring node 20 to assist an air navigation service provider (ANSP) 40 in the design of an airspace 61. The monitoring node 20 collects flight data and performs flight simulations for a large geographic region 50. The monitoring node 20 receives flight data collected by the ANSP 40 for the airspace 61. The monitoring node 20 supplements the flight data with the data received from the ANSP 40 and performs flight simulations and generates flight plans for the airspace 61. The flight simulations and flight plans are transmitted to the ANSP 40 which are then used by the ANSP 40 to design the airspace 61.

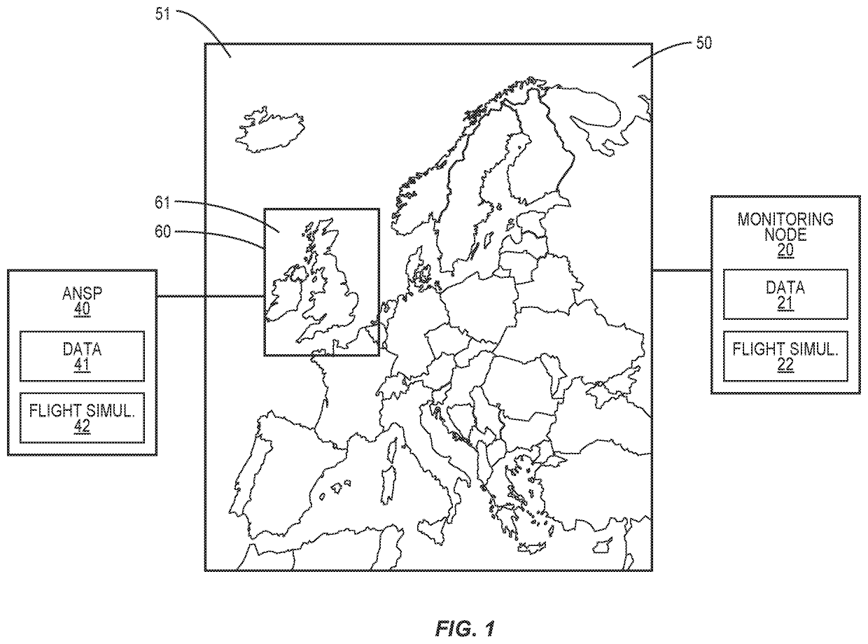

FIG. 1 illustrates a monitoring node 20 that monitors flight data within a geographic region 50. The geographic region 50 can include various sizes and configurations. In one example, the geographic region 50 covers the entire globe (i.e., worldwide). In another example the geographic region 50 is smaller, such as Europe as illustrated in FIG. 1. Other examples include a geographic region that is limited to an area (e.g., European Union) or a country (i.e., France, Germany). The geographic regions 50 include an airspace 51 that extends over the geographic region 50.

The monitoring node 20 collects and maintains flight data for the airspace 51. The flight data includes a variety of data that relates to flights within the airspace 51 of the geographic region 50. The flight data 21 includes various aspects, including but not limited to airports, and obstacles. Examples of airport data include the location of airports within the geographic region 50, the number of runways, runway alignment, hard surfaces, taxiways, aprons, and holding positions. The airport data can also include the number of flights into and out of the airport, airlines operating at the airport, and the number of gates.

The obstacle data can include but is not limited to geological structures within the geographic region 50, such as geographic coordinates (latitude and longitude) of mountains, buildings, towers, power lines, and no-fly zones. The obstacle data can include relevant information for each obstacle such as the elevation, geographic area, and lighting.

The monitoring node 20 maintains updated flight data 21 for the geographic region 50. In one example, the monitoring node 20 queries the information from sources (e.g., airports, airlines, aircraft) that operate within the geographic region 50 to obtain updated/additional flight data 21. Additionally or alternatively, sources periodically provide this information to the monitoring node 20.

The monitoring node 20 is configured to generate flight planning simulations 22 using the flight data 21. The monitoring node 20 includes one or more models having algorithms and equations that use the flight data to capture the behavior of flights within the geographic region 50. The flight planning simulations 22 output flight plans that extend within the airspace 51. In one example, flight plans include a planned route of an aircraft through the airspace 51 and can include one or more of: departure point, arrival point, route information, estimated flight time, alternative airports, type of flight (e.g., IFR, VFR), flight path, waypoints, airway segments, flight levels, fuel usage, approach procedures, elevations during flight, airspeed, air distance traveled, and holding patterns.

As illustrated in FIG. 1, one or more subregions 60 are located within the geographic region 50. The size of the subregion 60 can vary with sizes including but not limited to continents, countries, states, and various other geographic areas. In one example as illustrated in FIG. 1, the subregion 60 is smaller than and contained within the geographic region 50. Other examples include the subregion 60 positioned along an edge of the geographic region 50, or away from the geographic region 50.

The subregion 60 includes an airspace 61 that is serviced by the ANSP 40. The ANSP 40 provides various air navigation services within the subregion 60. Services include but are not limited to air traffic management, aircraft communications, weather service, search and rescue, and various aeronautical information services. Examples of an ANSP 40 include but are not limited to National Air Traffic Services (NATS), Federal Aviation Administration (FAA), EUROCONTROL, Japan Civil Aviation Bureau, Nav Canada, and Swedish Civil Aviation Administration.

The ANSP 40 collects data 41 about flights in the subregion airspace 61. The data 41 can include one or more of the same types of data (i.e., airports, obstacles, and operational data) described above for the flight data 21. In one example, the ANSP 40 collects different and/or additional data than the flight data 21. In one example, the monitoring node 20 does not collect data within the subregion 60 and relies upon the collection and submission of the data from the ANSP 40. In another example, both the monitoring node 20 and the ANSP collect flight data for the airspace 61 with the data 41 from the ANSP 40 being more complete and/or includes more information than is available to the monitoring node 20.

In one example, the ANSP 40 is further configured to run flight simulations 42. The flight simulations 42 output flight plans for flights that move through the airspace 61. The flight simulations 42 are limited relative to the flight simulations 22 from the monitoring node 20. The limitations can be due to one or more of the limited data available to the ANSP 40, the inability of the flight simulations 22 to use data from outside of the subregion 60, and the technical ability of the flight simulation 42 that are not as robust as the flight simulations 22. These lacking flight simulations and resulting output demonstrate the need for the ANSP 40 to work with the monitoring node 20 to run more effective flight simulations and provide more accurate and complete flight plans.

The ANSP 40 also designs the airspace 61 for the subregion 60. The airspace design can include but is not limited to planning and design of routes, holding patterns, airspace structure, and air traffic control (ATC) sectorization in both terminal and in-route airspace. The airspace design applies to flights that begin in the airspace 61, end in the airspace 61, and/or fly through the airspace 61. In one example, the airspace design applies to the entire airspace 61. In another example, the design is limited to one or more limited aspects of the airspace 61. In one example, the airspace design applies to Free Route Airspace (FRA) within the overall airspace 61.

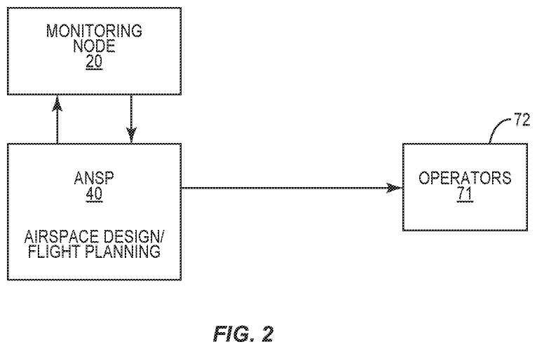

FIG. 2 schematically illustrates the process in which the monitoring node 20 supports the ANSP 40 to provide the ANSP 40 with one or more of flight data 21, flight simulation support, and improved flight plan generation. The monitoring node 20 exchanges information with the ANSP 40 and provides one or more of flight data management and flight simulation. The communication between the monitoring node 20 and the ANSP 40 provides for an iterative process. The iterative process includes the monitoring node 20 generating multiple different outputs based on new/updated requests from the ANSP 40. The iterative process can also be implemented due to analysis provided by the monitoring node 20 that causes additional processing to occur. For example, a flight plan generated by the monitoring node 20 can result in excessive congestion at one or more ATC sectors within the subregion 60 and thus require additional changes and analysis by the monitoring node 20. The flight plans generated by the monitoring node 20 are output to the ANSP 40 which can then make additional changes to the airspace design requiring additional flight simulations by the monitoring node 20. In one example, the ANSP 40 requests flight simulations for a first aspect such as the entire airspace 61. Based on the results of this initial analysis, the ANSP 40 subsequently requests more specific flight simulations about one or more aspects of the airspace 61 (e.g., the FRA region).

In one example, the process flow includes data for the subregion airspace 61 is collected by the ANSP 40 and transmitted to the monitoring node 20. In one example, this data is exported from modeling tools at the ANSP 40 to the monitoring node 20.

The monitoring node 20 integrates the data 41 from the ANSP 40 in a variety of different manners. In one example, the data 41 replaces or supplements the flight data 21 already maintained by the monitoring node 20. In another example, the data 41 from the ANSP 40 is not otherwise collected by the monitoring node 20. Thus, this data 41 is new and added to the existing flight data 21 to provide more complete data on which to use in the flight simulations.

FIG. 2 generally illustrates the process of the airspace design. The ANSP 40 and monitoring node 20 communicate during the initial phase of the process. The ANSP 40 provides flight data to the monitoring node 20 which is then able to run flight simulations and generate flight plans. In another example, the ANSP 40 does not provide flight data to the monitoring node 20 as the monitoring node 20 runs the flight simulations based on their own collected data.

After generation, the information is transmitted to the ANSP 40 which analyzes the information and make further refinements that are used for the airspace design/flight planning In one example, the ANSP 40 uses the information from the monitoring node 20 and performs its own simulations and data gathering that are used for the final airspace design and/or flight planning.

The ANSP 40 receives the information and can establish the design of the airspace 61. After the initial design, the ANSP 40 can forward additional data/requests to the monitoring node 20 to perform additional flight simulations on the initial design. The monitoring node 20 performs the flight simulations and returns updated data to the ANSP 40. This process may continue through numerous steps as the airspace design is further refined to meet the demands of the ANSP 40.

Once the airspace design is completed, the ANSP 40 outputs the design to operators 71 that use the airspace 61 (block 72). The operators 71 can include but are not limited to airports, airlines, military, and pilots operating aircraft in the airspace 61. In one example, the operators 71 provide feedback to the ANSP 40 which can be used to change one or more constraints in the flight plans and improve the airspace 61. In one example, an operator provides the ANSP 40 with their set of flight planning parameters and operational preferences, as well as their future flight schedule. The ANSP 40 generates flight plans using this data and shares the flight plans with the operator 71. The operator 71 can then provide feedback regarding the flight plans.

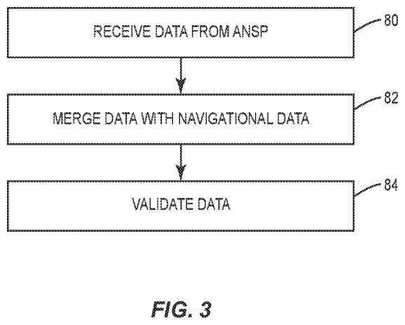

FIG. 3 illustrates a process by which the flight data 21 of the monitoring node 20 is updated and provided to the ANSP 40. The monitoring node 20 receives the subregion data 41 from the ANSP 40 (block 80). The subregion data 41 is merged with the existing flight data 21 (block 82) and the merged data is then used for the flight simulations. The merged data is validated by the monitoring node 20 to ensure the accuracy (block 84). In one example, the validation computes the difference between the new airspace design and the old airspace design. Reports are generated that can include the differences and can include various types of data, including but not limited to Keyhole Markup Language (KML) plots and textual data. The subregional data 41 is received by the monitoring node 20 in AIXM format and integrated with the flight data 21.

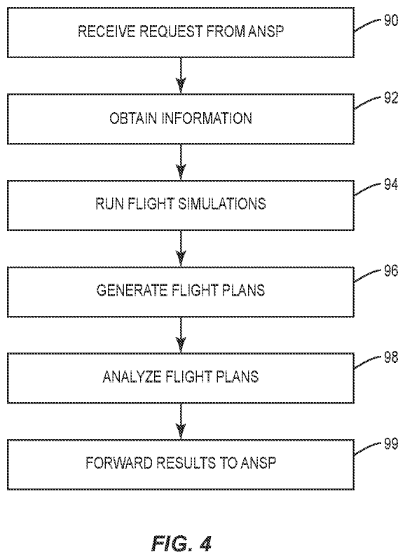

FIG. 4 illustrates a process of the monitoring node 20 performing flight simulations. In one example, the flight simulations are performed using the integrated flight data 21 that includes both the previously maintained flight data 21 and the subregion data 41 as outlined in FIG. 3. In another example, the flight simulations are performed using the flight data 21 maintained by the monitoring node 20 (i.e., without the data 41 from the ANSP 40).

The process includes receiving the request for the flight simulations from the ANSP 40 (block 90). The request can include the scope of the simulations. Examples include but are not limited to a request for flight simulations for the FRA, simulations for in-route flights, and simulations for flights that depart or end in the subregion 60.

The monitoring node 20 obtains the information applicable to the flight simulations (block 92). This includes the flight data 21 and can also obtain additional information from other sources. One example includes weather information such as from the National Oceanic and Atmospheric Administration (NOAA) and the National Weather Service (NWS). Another example includes flight schedule information from an airport or airline that operates in the subregion 60. The monitoring node 20 is configured to obtain this information from these outside sources prior to performing the flight simulations.

Once the information has been assembled, the monitoring node 20 runs flight simulations using one or more flight simulation models (block 94). Flight plans are generated from the flight simulations (block 96). The flight plans are then analyzed by the monitoring node 20 (block 98). The analysis can include key performance indicators such as but not limited to flight efficiencies, fuel usage, and airport efficiencies, abnormalities in the flight plans such as congestion, route availability, revenue, environmental effects (e.g., polluting emissions), noise, and cost decomposition. In one example, the analysis of the flight plans ranks the flight plans according to one or more of the key performance indicators. The flight plans and analysis are then sent to the ANSP 40 (block 99). In one example, the monitoring node 20 maintains the flight data 21 in accordance with ARINC 424 standard.

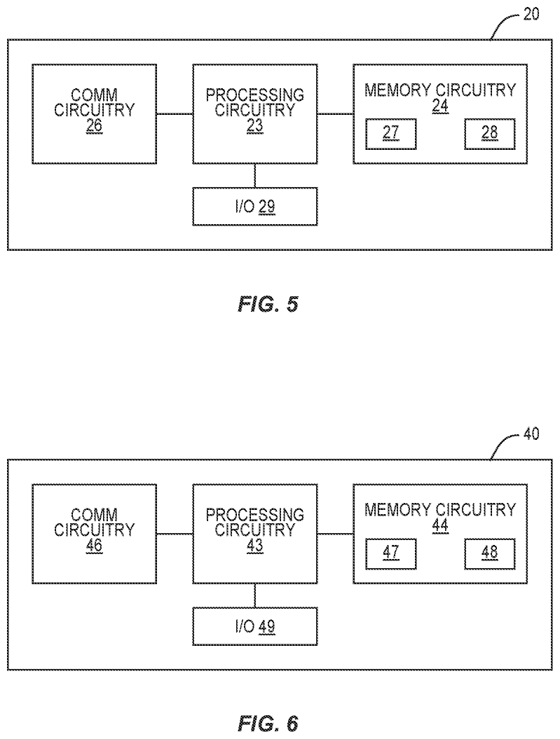

FIG. 5 is a functional block diagram of the monitoring node 20. The monitoring node 20 comprises processing circuitry 23, memory circuitry 24, and communications circuitry 26.

The processing circuitry 23 is communicatively coupled via one or more buses to the memory circuitry 24, I/O interface 25, and communications circuitry 26. The processing circuitry 23 can include one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. In one example, the processing circuitry 23 includes programmable hardware capable of executing software instructions stored, e.g., as a machine-readable computer control program 27 in memory circuitry 24. More particularly, the processing circuitry 23 is configured to execute a control program 27 to generate the flight simulations of flights within the airspace 61 and/or maintain the flight data 21. The processing circuitry 23 is configured to implement this functionality in accordance with the data and information stored in a database 28. The database 28 is stored in a non-transitory computer readable storage medium (e.g., an electronic, magnetic, optical, electromagnetic, or semiconductor system-based storage device). The database 28 can be local or remote relative to the monitoring node 20. In one example, the database 28 is incorporated in the memory circuitry 24.

The communications circuitry 26 is configured to facilitate the communication with the ANSP 40. In one example, the communications circuitry 26 includes a transceiver configured to send and receive communication signals through one or more wireless communications networks, satellites, and landline systems.

An I/O interface 29 comprises circuitry configured to allow the monitoring node 20 to communicate with a user and can comprise a variety of different devices and/or circuitry. However, in one aspect, I/O interface 29 includes, but is not limited to, display devices such as a Liquid Crystal Display (LCD) and/or a Light Emitting Diode (LED) display for presenting visual information to a user located at the monitoring node 20 such as a worker at the monitoring node 20 that is reviewing the flight plans that are generated by the monitoring node 20. The I/O interface 29 can also include one or more graphics adapters, display ports, video buses, a touchscreen, a graphical processing unit (GPU), and audio output devices such as speakers, as well as circuitry and devices for accepting input from the user. Such input circuitry and devices include a pointing device (e.g., a mouse, stylus, touchpad, trackball, pointing stick, joystick), a microphone (e.g., for speech input), an optical sensor (e.g., for optical recognition of gestures), and/or a keyboard (e.g., for text entry). The user I/O interface 29 can be implemented as a unitary physical component, or as a plurality of physical components that are contiguously or separately arranged, any of which may be communicatively coupled to any other or communicate with any other component via processing circuitry 23.

FIG. 6 is a functional block diagram of the ANSP 40. The ANSP 40 comprises processing circuitry 43, memory circuitry 44, and communications circuitry 46. These components are similar to those explained above for the monitoring node 20. The processing circuitry 43 is configured to execute a control program 47 to generate the flight simulations and/or maintain the data 41. The processing circuitry 43 is configured to implement this functionality in accordance with the data and information stored in a database 48.

An I/O interface 49 comprises circuitry configured to allow the ANSP 40 to communicate with a user and can comprise a variety of different devices and/or circuitry. In one aspect, I/O interface 49 includes, but is not limited to, display devices such as a Liquid Crystal Display (LCD) and/or a Light Emitting Diode (LED) display for presenting visual information to a user located at the ANSP 40 such as a worker at the ANSP 40 that is reviewing the flight plans and/or airspace design. The I/O interface 49 can also include one or more graphics adapters, display ports, video buses, a touchscreen, a graphical processing unit (GPU), and audio output devices such as speakers, as well as circuitry and devices for accepting input from the user. Such input circuitry and devices include a pointing device (e.g., a mouse, stylus, touchpad, trackball, pointing stick, joystick), a microphone (e.g., for speech input), an optical sensor (e.g., for optical recognition of gestures), and/or a keyboard (e.g., for text entry). The user I/O interface 49 can be implemented as a unitary physical component, or as a plurality of physical components that are contiguously or separately arranged, any of which may be communicatively coupled to any other or communicate with any other component via processing circuitry 43.

In one example, the monitoring node 20 generates flight plans that can be displayed on the I/O interface 29. The flight plans are transmitted to the ANSP 40 and can be displayed on the I/O interface 49. Changes to the flight data can be input through users at one or more of the I/O interfaces 29, 49 and processed by one or more of the monitoring node 20 and ANSP 40. The output due to the changes can be output on one or both of the interfaces 29, 49. In one example,

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of evaluating an airspace design of a subregion of a larger geographic region, the method comprising:
receiving at a monitoring node subregion data for airspace of the subregion, the subregion data being received from an air navigation service provider;
integrating the subregion data with flight data of geographic region airspace, with the flight data being maintained by the monitoring node;
processing flight planning simulations using the flight data that has been integrated with the subregion data;
generating flight plans from the flight planning simulations; and
transmitting the flight plans to the air navigation service provider.

2. The method of claim 1, further comprising receiving the subregion data in Aeronautical Information Exchange Model (AIXM) format.

3. The method of claim 1, wherein the subregion is contained within the larger geographic region.

4. The method of claim 1, further comprising generating the flight plans for flights within Free Route Airspace (FRA) that extend within the airspace of the subregion.

5. The method of claim 1, further comprising processing the flight planning simulations using global weather data.

6. The method of claim 1, further comprising processing the flight planning simulations using flight schedules for one or more of the geographic region and the subregion.

7. The method of claim 1, wherein integrating the subregion data with the navigation data comprises replacing a portion of the flight data with the subregion data.

8. The method of claim 1, further comprising generating the flight data of the geographic region airspace prior to receiving the subregion data from the air navigation service provider.

9. The method of claim 1, further comprising transmitting the flight data of the geographic region airspace to the monitoring node in ARINC 424 format.

10. The method of claim 1, further comprising transmitting a flight data validation report to the air navigation service provider after integrating the subregion data with the flight data.

11. The method of claim 1, further comprising ranking the flight plans based on one or more aspects comprising flight efficiencies, fuel usage, and emissions output.

12. A method of evaluating an airspace design of a subregion of a larger geographic region, the method comprising:
maintaining flight data for the larger geographic region at a monitoring node;
receiving at the monitoring node subregion data for a subregion of the larger geographic region, the subregion data being received from an air navigation service provider;
performing flight simulations using one or more of the flight data and the subregion data;
generating flight plans from the flight simulations with the flight plans extending within the subregion;
analyzing the flight plans and determining one or more key performance indicators for the flight plans;
displaying the flight plans and the one or more key performance indicators;
transmitting the flight plans and the one or more key performance indicators to the air navigation service provider.

13. The method of claim 12, further comprising:
receiving a request from the air navigation service provide;
running additional flight simulations using information from the request; and
displaying updated flight plans that include the information from the request.

14. The method of claim 12, further comprising ranking the flight plans based on congestion of a subregion airspace that extends over the subregion.

15. The method of claim 12, further comprising receiving the subregion data in Aeronautical Information Exchange Model (AIXM) format and integrating the subregion data in the flight data.

16. The method of claim 13, further comprising generating the flight plans for Free Route Airspace within the airspace of the subregion.

17. The method of claim 12, further comprising:
maintaining the flight data for the larger geographic region at a monitoring node with the navigation data being devoid of any data from the subregion; and
generating the updated flight data by adding the subregion data to the flight data.

18. The method of claim 12, further comprising transmitting the updated flight data to the monitoring node in ARINC 424 format.

19. A non-transitory computer readable medium comprising instructions stored thereon that, when executed by processing circuitry of a computing device, configures the computing device to:
receive subregion data for airspace of a subregion, the subregion data being received from an air navigation service provider;
integrate the subregion data with flight data of a geographic region that encompasses the subregion;
process flight planning simulations using the flight data that has been integrated with the subregion data;
generate flight plans from the flight planning simulations; and
transmit the flight plans.

20. The non-transitory computer-readable medium of claim 19, further comprising the flight plans being limited to the airspace over the subregion.
